(19) United States
(12) Patent Application Publication
(10) Pub. No.: US 2007/0116439 A1
(43) Pub. Date: May 24, 2007

(54) Reproducing apparatus and reproducing method

(76) Inventor: Koji Maruyama, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,068

(22) Filed: Nov. 20, 2006

(30) Foreign Application Priority Data
Nov. 21, 2005 (JP) 2005-336225

(51) Int. Cl. H04N 7/26

(52) U.S. Cl. 386/112

(57) ABSTRACT

Systems and methods control an analog output of an information reproducing apparatus, such as a high-definition DVD player. At least partially in response to a determination that a multimedia presentation is content protected, one embodiment reduces a displayed resolution of an analog output to less than a full available resolution. In another embodiment, the analog output for the multimedia presentation is disabled, and the analog output carries an instruction for a user to switch to a digital output of the reproducing apparatus.

### CROSS-REFERENCE TO RELATED APPLICATIONS

This application is based upon and claims the benefit of priority from the prior Japanese Patent Application No. 2005-336225, filed Nov. 21, 2005, the entire contents of which are incorporated herein by reference.

### BACKGROUND

1. Field

One embodiment of the invention relates to a reproducing apparatus for reproducing a video image signal together with content protection information, and in particular to a reproducing apparatus and a reproducing method for carrying out output control of an analog video image signal.

2. Description of the Related Art

Recently, an apparatus for reproducing digital content has been generally available with prevalence of digital equipment, making it possible to reproduce video image information more easily than in the case of a reproducing process using an analog VTR (Video Tape Recorder). In such a digital reproducing apparatus, resolution can be very high, and thus, there is a situation in which content copyrights cannot be protected unless there is provided predetermined copy protection relevant to an analog video image signal as well as copy protection of digital contents.

Here, in patent document 1 (Jpn. Pat. Appln. KOKAI Publication No. 2005-25270), in the case where analog output disable information has been read out with respect to an analog video image signal, a reproducing mechanism does not provide a video image as an analog output. Thus, a video image is outputted to only a digital output terminal side, thereby preventing illegal copying of content from the analog signal.

### BRIEF DESCRIPTION OF THE SEVERAL VIEWS OF THE DRAWINGS

The drawings and the associated descriptions are provided to illustrate embodiments of the invention and not to limit the scope of the invention.

FIG. 1 is a block diagram depicting an example of a configuration of a reproducing apparatus according to an embodiment of the invention;

FIG. 2 is a block diagram depicting an example of a configuration of a recording/reproducing apparatus according to an embodiment of the invention;

FIG. 3 is a flow chart showing an example of an output limiting process (analog signal control) in a reproducing apparatus according to an embodiment of the invention;

FIG. 4 is a flow chart showing an example of an output limiting process (resolution control) in a reproducing apparatus according an embodiment of the invention;

FIG. 5 is a flow chart showing an example of an output limiting process in a reproducing apparatus according to an embodiment of the invention;

FIG. 6 is an illustrative view showing an example of connection between a reproducing apparatus and a display apparatus according to an embodiment of the invention; and

FIG. 7 is an illustrative view showing an example of a screen for displaying a message of an output control process in a reproducing apparatus according to an embodiment of the invention.

### DETAILED DESCRIPTION

Various embodiments according to the invention will be described hereinafter with reference to the accompanying drawings. In general, according to one embodiment of the invention, there is provided a reproducing apparatus including: a decoder section which receives a video image signal together with content protection information and decoding the received signal to a digital video image signal; a detecting section which detects control information on an analog video image signal from the content protection information; a converter section which converts the digital video image signal detected by the detecting section into an analog video image signal; a control section which controls an external output of the analog video image signal converted by the converter section, based on the control information on the analog video image signal detected by the detecting section; and a generator section which generates a display signal for displaying the fact that the external output of the analog video image signal has been controlled and outputs the generated signal to an output terminal of the analog video image signal.

Hereinafter, preferred embodiments of the invention will be described in detail with reference to the accompanying drawings.

<Reproducing Apparatus According to an Embodiment of the Invention>

(Configuration)

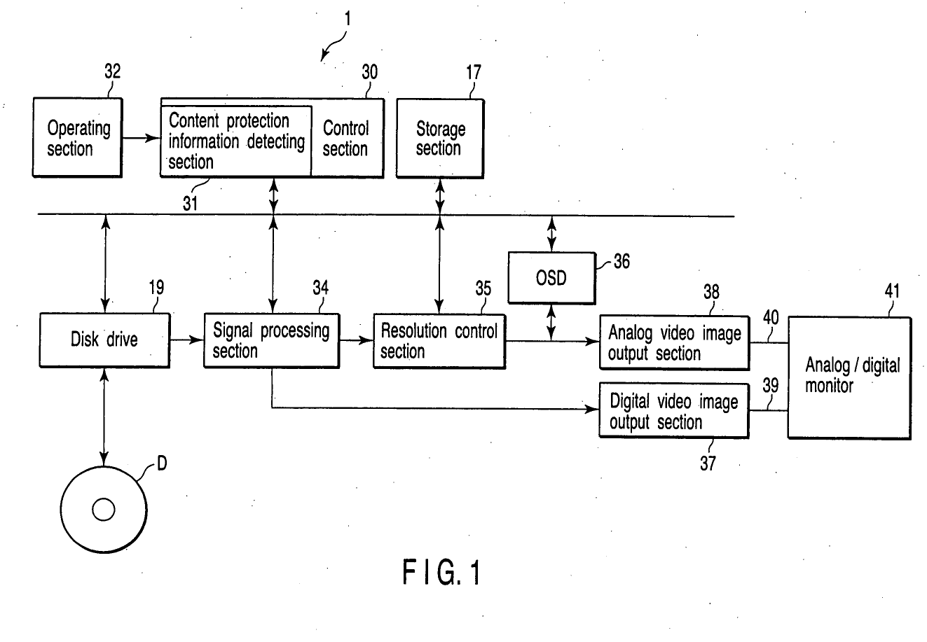

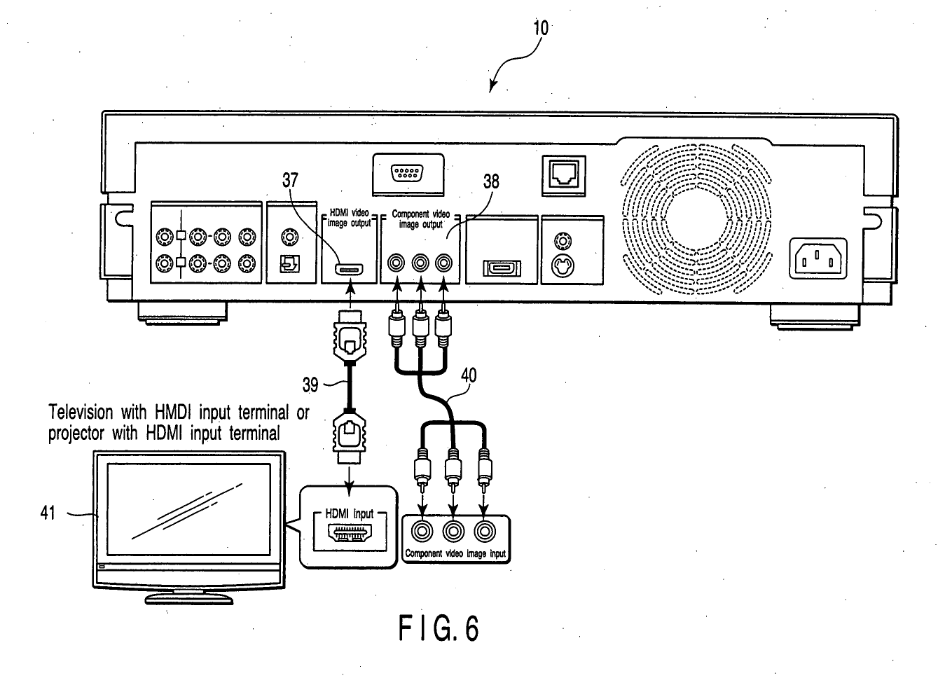

FIG. 1 is a block diagram depicting an example of a configuration of a reproducing apparatus according to an embodiment of the invention. A reproducing apparatus 1 of FIG. 1 has: a control section 30 for controlling operations of constituent elements in the reproducing apparatus by a microcomputer or the like as an example; a disk drive section 19 connected to the control section 30 via a data bus and reading out recording information contained in an optical disk D (such as high density digital versatile disc (HD DVD) or a general DVD, for example) by a pickup or the like; a signal processing section 34 for receiving this output signal and carrying out a decoding process of an MPEG decoder (or switching according to contents of data such as H. 264 and VC-1); a storage section 17 for storing content information; and an operating section 32 including a remote controller or the like, the operating section outputting an operating signal in response to an user operation. Further, the reproducing apparatus 1 has: a content protection information detecting section 31 for detecting content protection information from an output signal outputted from the signal processing section 34; a resolution control section 35 for controlling resolution of a reproduction signal from the signal processing section 34; an on screen display (OSD) section 36 for primarily generating a message screen display relating to control of an analog video image output and superimposing the generated screen display on the analog video image output; a digital video image output section 37 for outputting a digital video image signal; and an analog video image output section 38 for outputting an analog video image signal. This reproducing apparatus is connected to an external analog/digital monitor section 41 by a digital video image signal cable 39 such as a high definition multimedia interface (HDMI (registered trademark) cable as shown in FIG. 6 and an analog cable 40 such as a composite video image cable, similarly.

(Operation)

In the thus configured reproducing apparatus 1, a reproducing process will be described by way of example of an optical disk. Under the control of the control section 30, in an optical disk D rotated at a predetermined speed, a laser light beam is irradiated, and its reflection light beam is detected by an optical pickup, and a detection signal is output based on the detected beam. Based on this detection signal, an RF signal is generated, and a reproducing process is carried out after a data reading process.

Now, this reproducing process will be described in detail. The signal processing section 34 has a decoding (decompressing) function. This signal processing section includes a video processor for decoding the RF signal, properly combining a decoded subsidiary video image on a decoded main video image, and outputting a menu, a highlight button, a subtitle or other subsidiary video or graphical image to be superimposed on the main video image.

A video image voice signal from the signal processing section 34 is supplied to the resolution control section 35. In the resolution control section 35, a digital video image signal is properly converted into an analog video image signal, and the converted signal is supplied to the analog video image output section 38. In addition, the digital video image signal is supplied to the digital video image output section 37 without being converted. In addition, in the resolution control section 35, a control signal according to advanced access content system (AACS) or the like, which is content protection information detected by the content protection information detecting section 31, is supplied from the content protection information detecting section 31. This control signal is supplied to the digital video image output section 37 and the analog video image output section 38, thereby carrying out resolution control and analog video image output control, as described later. In addition, the on screen display (OSD) section 36, as described later, primarily generates a message screen display with respect to a control of an analog video image output, and then, superimposes the generated screen display on the analog video image output.

In addition, the digital video image output section 37, as shown in FIG. 6, can be connected to the digital/analog monitor 41 or the like via the digital video image signal cable 39, such as a high definition multimedia interface (HDMI) (registered trademark) cable, and/or the composite video image signal cable 40.

(Configuration of Other Embodiments)

In FIG. 1, while a description has been given by way of example of the reproducing apparatus 1 which is a mechanism used for reproduction, embodiments according to the invention are not limited to mechanisms exclusively used for reproduction. Embodiments can also include a reproducing apparatus 10 having a recording function. Hereinafter, an example of the reproducing apparatus 10 having a recording function will be described in detail with reference to the accompanying drawings.

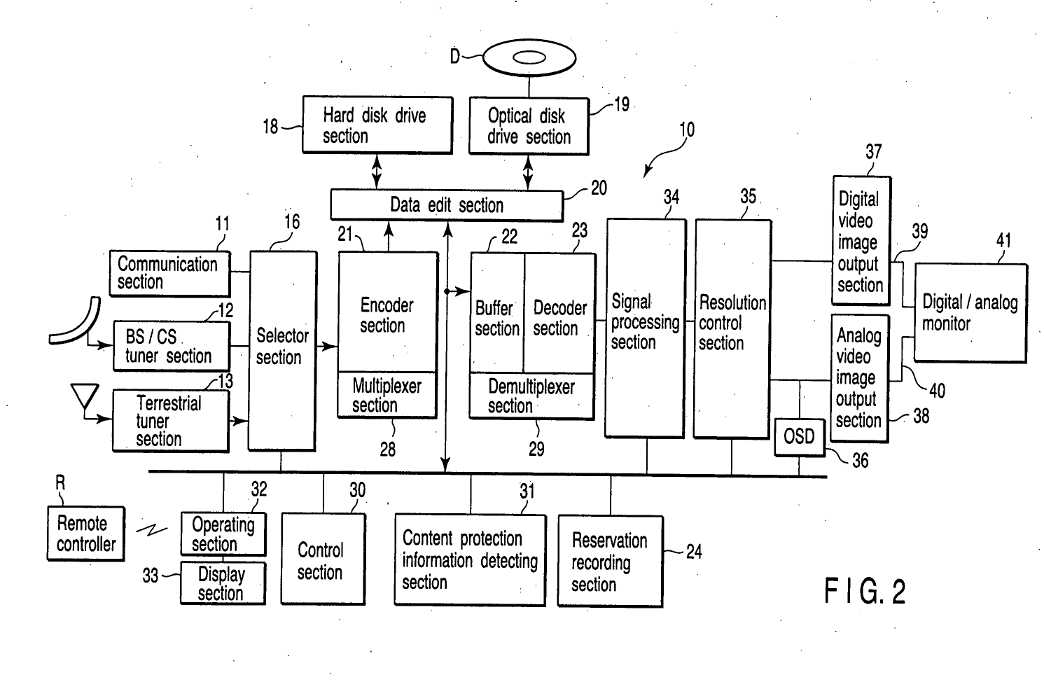

FIG. 2 is a block diagram depicting an example of a configuration of a reproducing apparatus according to another embodiment of the invention. The reproducing apparatus 10 of FIG. 2 has two types of disk drive sections. First, this reproducing apparatus has an optical disk drive section 19 for rotationally driving an optical disk D as a first medium which is an information recording medium capable of constructing a video file, and then, executing information reading and writing operations. Second, this reproducing apparatus has a hard disk drive section 18 for driving a hard disk as a second medium. In the illustrated embodiment, a control section 30 is connected to each section via a data bus in order to control drive operations.

The reproducing apparatus 10 of FIG. 2 includes an encoder section 21 which configures a recording side, a decoder section 23 which configures a reproducing side, and the control section 30 for controlling an operation of equipment main body. The reproducing apparatus 10 has an input side selector 16. A communication section 11 such as LAN, a satellite broadcast (BS/CS) tuner section 12, and a terrestrial tuner section 13 are connected to the input side selector 16, and a signal is outputted to the encoder section 21. In addition, a satellite antenna is connected to the BS/CS tuner section 12, and a terrestrial antenna is connected to the terrestrial tuner section 13. In addition, the reproducing apparatus 10 has: the encoder section 21; a data edit section 20 for receiving an output from the encoder section 21 and carrying out desired data processing such as data edit; and the hard disk drive section 18 and the optical disk drive section 19 which are connected to the data edit section 20. Further, the reproducing apparatus 10 has: the decoder section 23 for receiving a signal from the hard disk drive section 18 or optical disk drive section 19 and decoding (decompressing) the received signal; the encoder section 21; a buffer section 22; a multiplexer section 28; a demultiplexer 29; and a reservation recording section 24. These sections can be connected to the control section 30 via a data bus for operation control.

Further, the reproducing apparatus 10 has an operating section 32 connected to the control section 30 via a data bus, the operating section receiving an operation of a user or an operation of a remote controller R. Here, the remote controller R enables operation which can be substantially identical to the operating section 32 provided at the main body of the reproducing apparatus 10. This remote controller enables a variety of settings such as a recording or reproducing instruction of the hard disk drive section 18 or the optical disk drive section 19, an edit instruction, tuner operation, or setting of reservation recording.

(Operation)

Basic Operation

In the thus configured reproducing apparatus 10, an overview of a reproducing process and a recording process will be described by way of example of an optical disk. Under the control of the control section 30, in an optical disk D rotated at a predetermined speed, a laser light beam is irradiated, its reflection light is detected by an optical pickup, and a detection signal based on the detected light beam is outputted. Based on this detection signal, an RF signal is generated, and a reproducing process is carried out after a data reading process.

In addition, in a recording process of an optical disk, under the control of the control section 30, for example, data supplied via a selector section 16 is supplied to the encoder section 21 via an input section, although not shown, and the supplied data is encoded and outputted. In response to this encoded output and an output from the control section 30, a drive current of a laser driver is supplied to an optical pickup, and the resulting light beam is irradiated to a storage region of the optical disk D, whereby a recording process is carried out.

Recording Process or the Like

An operation of the reproducing apparatus 10 having such constituent elements will be described in more detail. First, an operation at the time of recording will be primarily described in detail including other embodiments. As an input side of the reproducing apparatus 10, the communication section 11 such as LAN is connected to an external device. This communication section makes communication with a program information providing server or the like, although not shown, through a communication channel such as the Internet via a modem or the like, although not shown, or downloads content information or the like, for example. In addition, the BS/CS tuner section 12 and the terrestrial tuner section 13 can channel-select and demodulate a broadcast signal via an antenna, and provide a video image signal and a voice signal, and are compatible with various types of broadcast signals. For example, these tuner sections cover a terrestrial analog broadcast, a terrestrial digital broadcast, a BS analog broadcast, a BS digital broadcast, and a CS digital broadcast or the like, without being limited thereto. In addition, for example, a tuner section of a terrestrial analog broadcast or two or three and more BS/CS tuner sections are provided instead of provision of only one tuner, whereby parallel functioning can be achieved in response to a request for reservation recording.

The previously described communication section 11 can be, for example, an IEEE 1394 interface, and can receive digital contents from an external device over a network. In addition, it is possible to receive a brightness signal, a color difference signal, a video image signal such as a composite signal, or a voice signal from an input terminal, although not shown. These inputs are controlled by the selector 16 controlled by the control section 30 or the like, and the controlled inputs are selectively supplied to the encoder section 21.

The encoder section 21 has: a video and audio analog/digital converter for digitizing an analog video signal or an analog audio signal inputted by the selector 16; a video encoder; and an audio encoder. Further, this encoder section also includes a subsidiary video image encoder. An output from the encoder section 21 is converted into a compression format such as predetermined MPEG, and the converted output is supplied to the previously described control section 30.

In addition, there is no need for incorporating the BS/CS tuner 12 or the like. It is preferred that the tuner be externally provided via a data input terminal, and a received digital signal be supplied to the encoder section 21 or the control section 30 via the selector section 16.

Here, the apparatus of FIG. 2 can supply information encoded in the encoder section 21 (pack such as video, audio, or subsidiary video image data) and produced management information to the hard disk drive section 18 or the optical drive section 19 via the control section 30, and record the supplied information in the hard disk drive 18 or an optical disk D. In addition, this apparatus can record the information recorded in the hard disk drive section 18 or the optical disk D, in the optical disk D or the hard disk drive section 18 via the control section 30 or the optical disk drive section 19.

Editing Process or the Like

The data edit section 20 can carry out an editing process such as partially deleting video objects of a plurality of programs recorded in the hard disk drive section 18 or the optical disk D or connecting objects of different programs.

Reproducing Process or the Like

Now, a process for reproducing recorded information will be primarily described in detail including other embodiments.

The decoder section 23 includes a video processor for properly combining a decoded subsidiary video image on a decoded (decompressed) main video image, and outputting a menu, a highlight button, a subtitle or other subsidiary video or graphical image to be superimposed on the main video image.

An output audio signal of the decoder section 23 is supplied to a signal processing section 34, the supplied signal is processed, and then, the processed signal is supplied to a resolution control section 35. In the resolution control section 35, a digital video image signal is properly converted into an analog video image signal, and the converted signal is supplied to an analog video image output section 38. In addition, the digital video image signal is supplied to a digital video image output section 37 without being converted. In addition, in the resolution control section 35, a control signal according to advanced access content system (AACS) or the like, which is content protection information detected by a content protection information detecting section 31, is supplied from the content protection information detecting section 31. This control signal is supplied to the digital video image output section 37 and the analog video image output section 38, thereby carrying out resolution control and analog video image output control, as described later. In addition, an on screen display (OSD) section, as described later, primarily generates a message screen display with respect to a control of an analog video image output, and then, superimposes the generated screen display on the analog video image output.

In addition, the digital video image output section 37, as shown in FIG. 6, is connected to a digital/analog monitor 41 or the like via the digital video image signal cable 39 such as high definition multimedia interface (HDMI) (registered trademark) cable and the composite video image signal cable 40.

Reservation Recording Process

In addition, based on electronic program information acquired from the communication section 11 or the like, it is possible to carry out a recording reservation process in accordance with a program specified by a user operation of a remote controller R or the like, with reference to a recording reservation list or a program chart. Based on the reserved reservation recording information, by the operation of the control section 30 and the reservation recording section 24, when a reservation time is reached, a video image voice signal obtained by demodulating program information received by the BS/CS tuner section 12 or the terrestrial tuner section 13 is recorded (reserved) in the hard disk drive 18, for example, through an encoding process by the encoder section 21 or the like.

The reproducing apparatus 10 has many functions, and carries out a recording/reproducing process by an optical disk D or the hard disk drive section 18 with respect to the various sources of data to be recorded.

<Example of Analog Video Image Signal Control Process According to an Embodiment of the Invention>

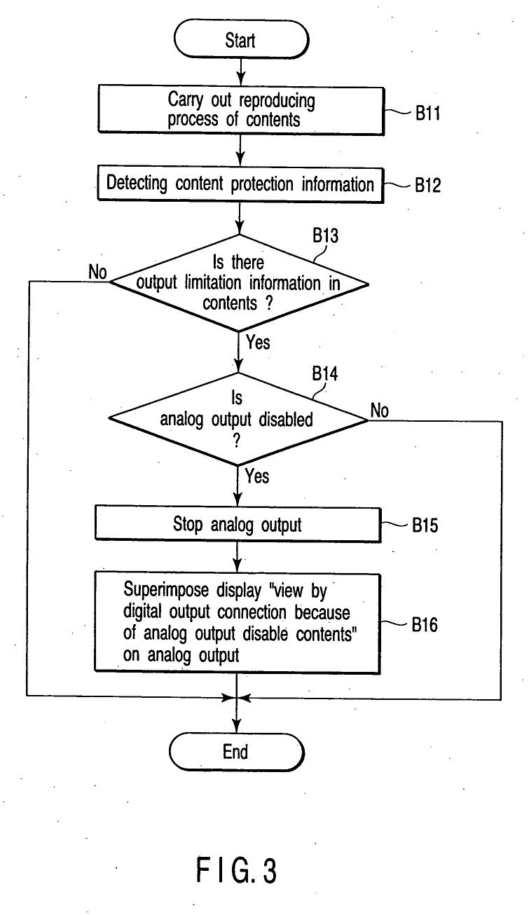

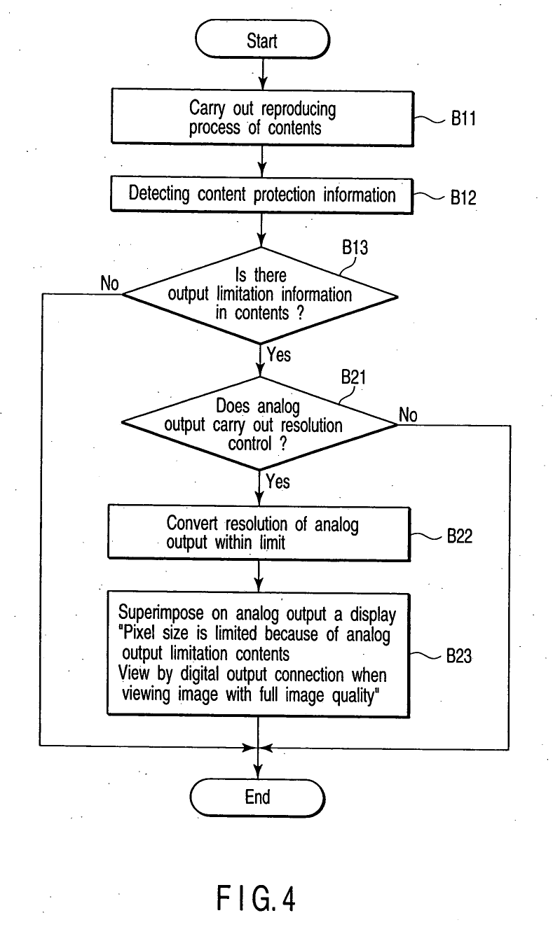

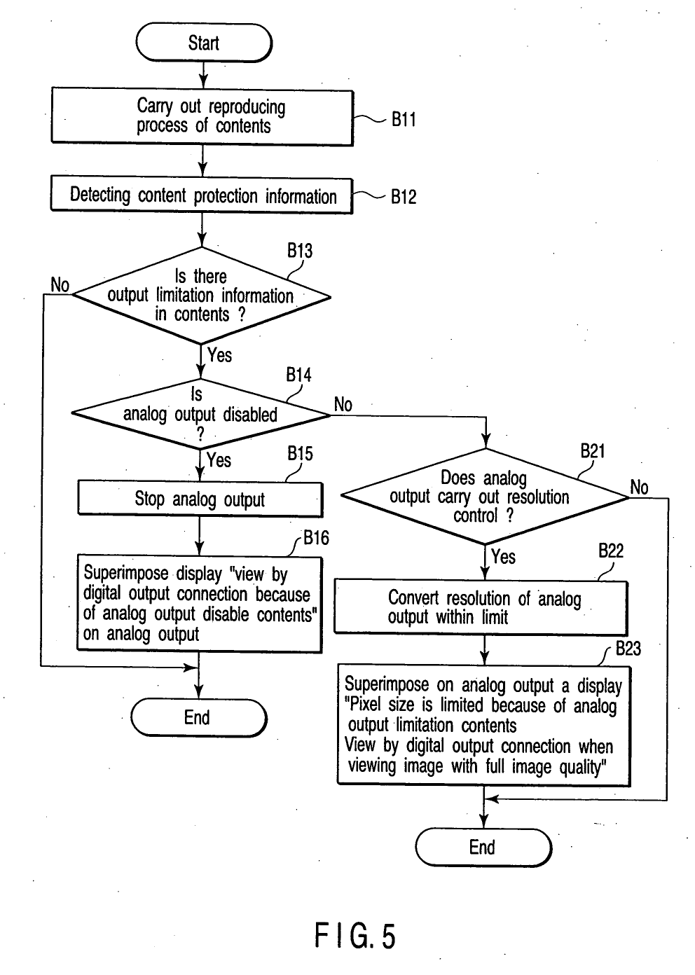

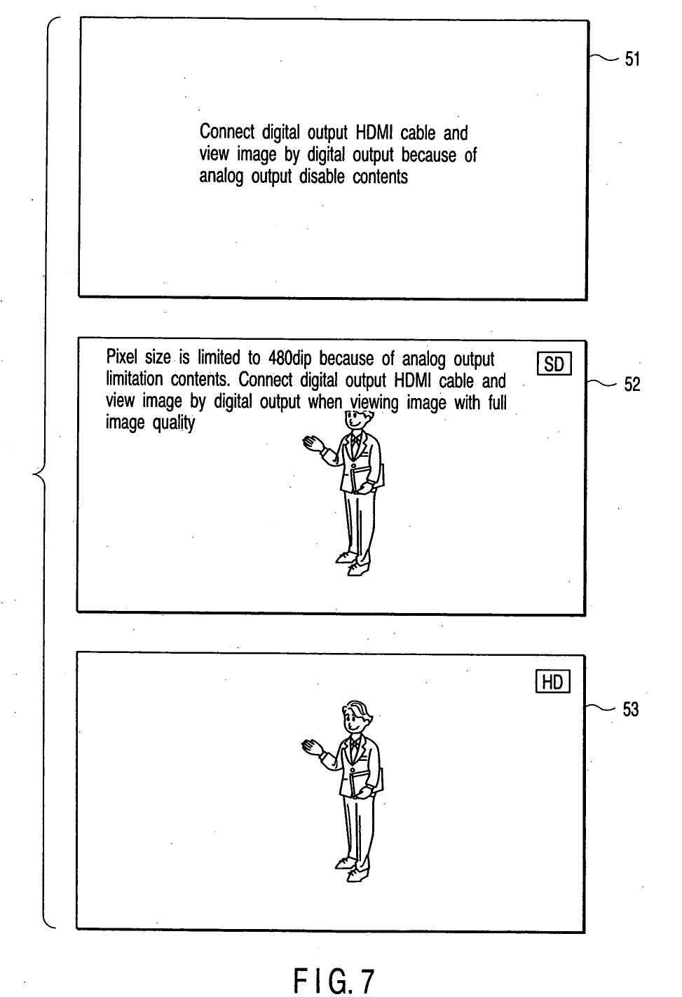

Now, an example of a process for controlling an analog video image, in particular, of the above-described reproducing apparatus 1 or reproducing apparatus 10 will be described in detail with reference to the accompanying drawings. A process for controlling an analog video image signal is an operation common to the reproducing apparatus 1 and the reproducing apparatus 10. FIG. 3 is a flow chart showing an example of an output limiting process (analog signal control) in a reproducing apparatus according to an embodiment of the invention; FIG. 4 is a flow chart showing an example of an output limiting process (resolution control) in a reproducing apparatus according an embodiment of the invention; FIG. 5 is a flow chart showing an example of an output limiting process in a reproducing apparatus according to an embodiment of the invention; FIG. 6 is an illustrative view showing an example of connection between a reproducing apparatus and a display apparatus according to an embodiment of the invention; and FIG. 7 is an illustrative view showing an example of a screen for displaying a message of an output control process in a reproducing apparatus according to an embodiment of the invention.

Stopping Analog Video Image Signal

First, a description will be given with respect to a process for stopping an analog video image signal in accordance with content protection information in the reproducing apparatus 1. The content protection information used here is provided as an example of a content protection flag of advanced access content system (AACS) together with content information, without being limited thereto.

In the case of using this AACS, some items of information are described in copy control information (CCI) of AACS. For example, this CCI can include conventional CCI information, an analog output limitation signal, an image quality limitation signal, and further, other information. In one embodiment, the analog output limitation signal and the image quality limitation signal are used as AACS content protection flags.

In the flow chart of FIG. 3, the reproducing apparatus 1, for example, reproduces HD DVD contents in the optical disk drive section 19 (block B11). Now, the content protection information detecting section 31 detects a content protection flag of an analog video image signal from AACS included in the signal processing section 34 or the like (block B12). Then, a protection flag such as this AACS indicate output limitation of an analog video image (block B13). In particular, when it is indicated that an analog video image signal is not outputted (block B14), an output of an analog video image signal is stopped by a control signal supplied from the content protection information detecting section 31 to the resolution control section 35 (block B15).

That is, in the resolution control section 35, by the control signal supplied from the content protection information detecting section 31, an analog video image signal converted from a digital video image signal is stopped without being supplied to the analog video image output section 38. At this time, at the same time as when the analog video image signal is stopped, in a function for generating display information on the OSD 36, as shown in a screen 51 of FIG. 7, there is displayed a warning message such as “Connect digital output HDMI (registered trademark) cable and enjoy viewing by digital output because of analog output disable contents”.

In this way, for example, even if a video image has been interrupted during HD DVD reproduction, a user viewing a monitor 41 by an analog output can recognize that an analog video image display has been interrupted because of a normal operation process for content protection information, not because of a failure of a reproducing apparatus, and further, the interrupted video image can be viewed by a digital output by connecting a digital output HDMI (registered trademark) cable. This makes it possible for a user to grasp what is happening.

Therefore, if connection between the reproducing apparatus 1 and the monitor 41 is made by only an analog cable 40 shown in FIG. 6, the user can view a reproduced video image of a digital video image signal by connecting the HDMI (registered trademark) cable 39, operating a remote controller R or the like, and then, selecting reproduction of a digital video image signal.

Although a description has been given with respect to a case in which content information together with content protection information has been acquired by HD DVD reproduction, processing is carried out similarly with respect to content information merely given from an external terminal without being limited to the case in which disk reproduction has been made. A variety of methods for acquiring content information can be used similarly.

Pixel Size Limitation of Analog Video Image Signal

Now, a description will be given with respect to a pixel size limiting process of an analog video image signal in accordance with content protection information in the reproducing apparatus 1. The content protection information used here is provided as an example of a content protection flag of AACS together with content information without being limited thereto. In the flow chart of FIG. 4, the reproducing apparatus 1 reproduces HD DVD contents in the optical disk drive section 19 (block B11). Now, the content protection information detecting section 31 detects a content protection flag of an analog video image signal from AACS included in the signal processing section 34 or the like (block B12). Then, this protection flag of AACS or the like indicates an output limit of an analog video image signal (block B13). In particular, when it is indicated that resolution control of the analog video image signal is carried out (block B21), the resolution of the analog video image signal is reduced by a control signal supplied from the content protection information detecting section 31 to the resolution control section 35 (block B22).

That is, as an example, even if a user has preset resolution so as to make a display at 1080i or at 720p by a remote controller R or the like, the resolution control section 35 converts an analog video image signal into a lower resolution, such as 480p, for example, specified by a content protection flag in response to a control signal supplied from the content protection information detecting section 31 (block B22). In this manner, as shown in a screen 52 of FIG. 7, a video image with low resolution of 480p or the like is displayed. At this time, it is preferable that the lowered resolution be displayed by screen display such as “SD”, for example for a predetermined time interval.

Further, at this time, together with stoppage of an analog video image signal, in a function for generating display information on the OSD 36, as shown in the screen 52 of FIG. 7, there is displayed a warning such as “the pixel size is limited to 480 dpi because of analog output limit contents. Connect a digital output HDMI (registered trademark) cable and view the contents by a digital output when the contents are viewed with a full image quality”.

In this manner, for example, even if a video image has been displayed with lowered resolution during HD DVD reproduction or at the beginning of the reproduction, a user viewing the monitor 41 by an analog output can recognize that the resolution has been lowered because of a normal operation process for content protection information, not because of a failure of the reproducing apparatus. Further, the user can be aware that the video image can be viewed by a digital output by connecting a digital output HDMI (registered trademark) cable. This makes it possible for a user to grasp what is happening.

Therefore, if connection between the reproducing apparatus 1 and the monitor 41 is made by only the analog cable 40 shown in FIG. 6, the user can view a reproduced video image of a digital video image signal in full image quality by connecting the HDMI (registered trademark) cable 39, operating a remote controller R or the like, and then, selecting reproduction of a digital video image signal.

Stopping Analog Video Image Signal and Limiting Pixel Size

Further, it is possible to selectively carry out stopping of these analog video image signals and limiting the pixel size at the same time. That is, the flow chart of FIG. 5 indicates that operations in the flow charts of FIGS. 3 and 4 are selectively made in accordance with contents of the content protection flag of content protection information. A duplicate description is omitted here.

Here, in accordance with a judging process in block B14 and block B21, stopping of an analog video image signal or control of resolution is selectively carried out according to the contents of the content protection flag of AACS together with content information. With respect to a warning screen, as shown in the flow charts of FIGS. 3 and 4, the screens 51 and 52 of FIG. 7 are selectively displayed.

In this manner, copy protection of an analog video image signal is carried out according to the content protection flag, and a user can recognize a reason why a process for limiting the analog video image signal is carried out.

Each of the message screens using the above-described OCD is not always superimposed on an analog video image signal, and it is preferable that such each screen be displayed in a display region provided at the operating section 32 or on the display section 33. In this manner, even if a user views a digital video image screen, the user can view a message screen via the display region or display section 33.

As has been described above, the above-described reproducing apparatus can protect an analog video image signal while explaining a situation to the user because the apparatus carries out control of an external output of an analog video image signal (stop or resolution control) while indicating that an external output of the analog video image signal is controlled by a display signal.

While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, while described in the context of NTSC using an HD DVD, the principles and advantages of the disclosed techniques can also be applied to PAL (Phase Alternation by Line). Further, the principles and advantages described herein can also be applied to systems using a Blue-ray Disk or any other disk format.

What is claimed is:

1. A method of controlling the playback of multimedia data, the method comprising:
receiving multimedia data, wherein the multimedia data is in a digital form;
determining whether content protection is indicated for the multimedia data; and
at least partially in response to a determination that the content protection is indicated, performing:
inhibiting presentation of at least a visual portion of the multimedia data in analog form; and
providing an indication in analog form that the multimedia data is available for presentation in another form.

2. The method of claim 1, wherein the indication comprises a message in an analog video signal.

3. The method of claim 1, further comprising receiving the multimedia data from an optical disk, wherein determining whether content protection is indicated comprises inspecting the multimedia data for a content protection indicating flag.

4. The method of claim 1, wherein the content protection complies with Advanced Access Content System (AACS) standards.

5. The method of claim 1, wherein the indication in analog form comprises a message that the multimedia data is available at an High-Definition Multi-media Interface (HDMI) output.

6. A method of controlling the playback of multimedia data, the method comprising:
receiving multimedia data, wherein the multimedia data is in a digital form;
determining whether content protection is indicated for the multimedia data; and
at least partially in response to a determination that the content protection is indicated, reducing a resolution of an analog presentation of the multimedia data to less than a full available resolution for the multimedia data.

7. The method of claim 6, further comprising at least temporarily providing an indication in an analog output signal carrying the analog presentation, where the indication indicates that the resolution has been reduced.

8. The method of claim 6, further comprising providing an indication in an analog output signal carrying the analog presentation, where the indication indicates that a higher resolution output is available at a digital output signal.

9. The method as defined in claim 8, wherein the indication comprises a message that the multimedia data is available at an High-Definition Multi-media Interface (HDMI) output.

10. An apparatus for controlling the playback of multimedia data, the apparatus comprising:
a decoder configured to receive multimedia data, wherein the multimedia data is in a digital form;
an analog output for providing a decoded analog presentation of the multimedia data; and
a controller configured to determine whether content protection is indicated for the multimedia data, where, at least partially in response to a determination that the content protection is indicated, the controller is configured to:
inhibit presentation of at least a visual portion of the multimedia data at the analog output; and
provide an indication at the analog output that the multimedia data is available for presentation in another form.

11. The apparatus of claim 10, further comprising an optical drive, wherein the multimedia data is retrieved by the optical drive from an optical disk, wherein content protection is indicated with a content protection indicating flag.

12. The apparatus of claim 10, wherein the content protection complies with Advanced Access Content System (AACS) standards.

13. The apparatus of claim 10, wherein the digital output comprises an High-Definition Multi-media Interface (HDMI) output, and wherein the indication at the analog output comprises a message that the multimedia data is available at the High-Definition Multi-media Interface (HDMI) output.

14. An apparatus for controlling the playback of multimedia data, the apparatus comprising:
a decoder configured to receive multimedia data, wherein the multimedia data is in a digital form;
an analog output for providing a decoded analog presentation of the multimedia data; and
a controller configured to determine whether content protection is indicated for the multimedia data, where the controller is further configured to, at least partially in response to a determination that the content protection is indicated, reduce a resolution of a presentation of the multimedia data at the analog output to less than a full available resolution for the multimedia data.

15. The apparatus of claim 14, wherein the controller is further configure to provide an indication at the analog output that the resolution of the presentation carried by the analog output has been reduced.

16. The apparatus of claim 14, wherein the controller is further configured to provide an indication at the analog output that a higher resolution output is available at a digital output of the apparatus.

17. The apparatus of claim 14, wherein the digital output comprises an High-Definition Multi-media Interface (HDMI) output, and wherein the indication at the analog output comprises a message that the multimedia data is available at the High-Definition Multi-media Interface (HDMI) output.

18. The apparatus of claim 14, wherein the apparatus further comprises an optical drive, wherein the multimedia data is retrieved by the optical drive from an optical disk, wherein content protection is indicated with a content protection indicating flag.

19. An apparatus for controlling the playback of multimedia data, the apparatus comprising:
means for receiving multimedia data, wherein the multimedia data is in a digital form;
means for determining whether content protection is indicated for the multimedia data; and
means, at least partially responsive to a determination that the content protection is indicated, for:
inhibiting presentation of at least a visual portion of the multimedia data in analog form; and
providing an indication in analog form that the multimedia data is available for presentation in digital form.

20. An apparatus for controlling the playback of multimedia data, the apparatus comprising:
means for receiving multimedia data, wherein the multimedia data is in a digital form;
means for determining whether content protection is indicated for the multimedia data; and
means, at least partially responsive to a determination that the content protection is indicated, for reducing a resolution of an analog presentation of the multimedia data to less than a full available resolution for the multimedia data.
